(19) United States
(12) Patent Application Publication
(10) Pub. No.: US 2004/0177030 A1
(43) Pub. Date: Sep. 9, 2004

(54) Psychometric Creditworthiness Scoring for Business Loans

(76) Inventor: Dan Shoham, San Diego, CA (US)

Correspondence Address: Dan Shoham, Oscore Corporation, 5230 Fiore Terrace #K311, San Diego, CA, 92122

(21) Appl. No.: 10/708,427

(22) Filed: Mar. 2, 2004

Related U.S. Application Data
(60) Provisional application No. 60/451,202, filed on Mar. 3, 2003.

(51) Int. Cl. G06F 17/60

(52) U.S. Cl. 705/38

(57) ABSTRACT

An automated system evaluates the creditworthiness of organization using a predictive model that utilizes the responses of organization managers to psychometric interview questions. The system also administers automated interview via paper, computer, telephone, or Internet protocol. The system also monitors its own performance and regularly retrains its predictive model.

### BACKGROUND OF INVENTION

1. Field of the Invention

The invention relates generally to the evaluation of creditworthiness of organizations, including, for example, business borrowers. In particular, the invention relates to an automated business creditworthiness scoring system and method that uses predictive modeling to perform pattern recognition and classification in order to assess the impact of the personalities of individuals associated with the business on the business' creditworthiness.

2. Description of the Related Arts

In the following discussion, the terms “business,” “loan,” “creditworthiness,” and “managers” will be used for illustrative purposes; however, the techniques and principles discussed herein apply to other types of organizations and prospective business relationships and transactions that require risk management and an evaluation of the prospective counter-party, such as equity investments, charitable donations, business partnership, vendor relationship, franchise relationship, channel distribution and production agreement.

Prior to the widespread use of consumer credit scores starting in the 1980's, lenders were loath to make unsecured loans to even middle class consumers. Today, thanks to the availability of comprehensive credit bureaus and effective credit scores, US credit card lines of credit alone total nearly $4 trillion. An entire industry was enabled by the development of quantitative credit risk management technology.

Whereas managing risk and origination decisions for unsecured consumer loans is largely a solved problem there is currently no analogous tool for business loans. Business rating organizations such as D&B provide some information to lenders, but have been unable to duplicate the effectiveness of consumer credit reports and scores. Unlike consumer loans, past credit behavior of companies is not as strong a predictor of future creditworthiness and reporting is very sparse. Consequently, the usefulness of business credit reports is often limited to the occasional derogatory item that may be identified.

Lenders, and others who invest in businesses, often observe that the most important factor in their lending decision is the way they feel about the management of the borrowing company. Are the borrowers too aggressive when risking other's money? Are they too conservative to make a business successful? Are they ethical? Do they possess fortitude of character? Are they reliable? When facing future difficulties, will they cash out as much as possible and leave the lenders exposed, or will they fight and make sacrifices to keep their obligations? In contrast with the impersonal information described earlier, these personal characteristics are not currently metered or analyzed quantitatively. Lenders employ credit officers whose task is to evaluate the business' prospect using impersonal data, to perform due diligence evaluation of the supplied information, and, ultimately, to develop an opinion with regard to the personal characteristics of the management team.

Quantitative metering of personal characteristics, while unfamiliar to the financial industry, is a well-explored domain in psychology. Psychometrics, as this domain is known, has been researched and analyzed statistically and qualitatively for nearly a century. Psychometric tests are extensively used across a wide spectrum of applications including, among many: clinical psychology, personality typing, pre-employment screening, management of military manpower, marketing and segmentation, marriage counseling, education, and career planning. Personality typing tests, unlike exams of skills or domain knowledge, identify characteristics such as introversion-extroversion tendencies by asking questions such as “Do you prefer to be in a crowd or with only a few friends?” The Myers-Briggs personally typing test, for example, is continuing to grow in popularity nearly 70 years after it was introduced.

Creditworthiness of Business Loans

Prior to the widespread use of consumer credit scores starting in the 1980's (credit scores existed as early as the late 1950's, but they were not yet used extensively); lenders were loath to make unsecured loans to even middle class consumers. Unless one had mortgaged assets (such as a home or a car) or government guarantee (such as for a student loan), lenders expected the borrower to demonstrate a very strong financial position. It was sometimes quipped that the only people able to obtain unsecured loans were those who could prove they do not need the money.

The problem of how to manage and make origination decisions for unsecured consumer loans has largely been solved with the combination of effective credit bureaus and credit scores such as those provided by Fair Isaac and Company (commonly referred to as “FICO Scores”). Information that was available on consumers' credit reports at the time of loans origination was correlated with the subsequent performance of the respective loans to identify predictive patterns. A statistically derived formula expressing this correlation—in effect attempting to predict whether a loan will perform based on credit report information available at origination time—is at the core of every credit score. Lenders, eager to have access to credit reports and scores, have been willing to accept the costs and inconvenience of complete and timely reporting of consumer credit performance to the credit bureaus. The high degree of credit reports comprehensiveness farther enhanced the predictive abilities of the modeled credit scores.

With the mass popularization of credit scores, effective risk management of unsecured consumer loans became possible. Lenders are able to extend loan offers to the public with terms that are specifically tuned to the creditworthiness of each borrower and to know accurately and in advance the subsequent default rate. No lender, today, need ever again face a portfolio of unsecured consumer debt with unanticipated credit loss levels. The arena of competition between consumer lenders has thus shifted from being entirely that of fathoming credit risks to marketing techniques, attractive product offering, and encouraging usage. Today, thanks to the availability of effective credit scores, unsecured consumer loans—including credit card lines of credit—are ubiquitous in the middle class and even lower-income population segments. Today, utilized US credit card loans alone total over $600 billion and committed lines of credit approach $4 trillion (source: FDIC, 3 quarter, 2002). A sizable industry was enabled by the development of effective credit scores.

Whereas managing risk and origination decisions for unsecured consumer loans may be a largely a solved problem, there is currently no analogous tool for business loans. For very small businesses—perhaps employing 5 or fewer employees—a consumer credit score with respect to the principals may provide creditworthiness predictivity. In such small businesses, the credit behavior of the company may be strongly related to that of the principals. However, for larger businesses, the principals can assure that their personal credit is pristine—whether or not the business is doing well or managed prudently.

Business rating organizations and those who accumulate information about the creditworthiness of businesses (such as Standard and Poor, Moody, and D&B—we will refer to these entities here as “Business Bureaus,” somewhat analogous to the credit bureaus that monitor consumer's credit behavior information) have developed a niche for providing some information to lenders, but have been unable to duplicate the effectiveness of consumer credit scores. Unlike consumer loans, good past credit behavior of companies is not a strong predictor of future creditworthiness since companies often keep all their obligations until they are already in serious financial difficulties. Because predictivity is poor, the incentive for strong and timely reporting by lenders and other vendors is weak. In fact, it is counter-indicated: An entity that is owed money to by a financially tenuous business would not normally want to harm that business' access to credit elsewhere. With reporting sparse, at best, business bureaus are unable to provide effective scores even if predictivity was more inherent. In fact, the only reason many lenders procure business bureaus report is to check for the off-chance that negative information is actually on the report.

Current business loan scoring and origination decisions typically utilize impersonal information. Loan applicants are asked to supply financial reports, tax filings, and business plans. Information from business bureaus is added (particularly if derogatory information is presented), and a score of the combined data is computed using the predictive modeling paradigm. Unfortunately, such scores are not considered very effective. Financial information supplied by the applicant is suspect (it is typically not audited, unless the borrower is publicly traded or very large; and even audited financial statements are sometimes misleading), business plans can be unrealistic, and business bureaus data is not very predictive.

The state of the business lending market today is thus still in a pre-tool stage of development. Businesses—particularly small or young enterprises with unproven cash flow and assets—find that they need to demonstrate a strong financial position to be considered for a loan. One might paraphrase the quip above to say that the only businesses that can get loans today are those that can demonstrate that they do not need the money. From a macroeconomical point of view, this is a pity since businesses are ultimately productive enterprises with the potential to simultaneously grow capital and profitably service their loans.

Psychometric Scoring and Personality Typing

Sigmund Freud, credited with the development of psychoanalysis, was among the first medical and academic professionals to explore the complexity of human personality. As early as the 1890's, he became convinced that one's personality is fixed long before the onset of adulthood and remains unchanged thereafter. He also put forth a theoretical structure to explain how the personality is formed in the first place. Freud's two most important colleagues, the Viennese physician Alferd Adler and the Swiss psychiatrist Carl Jung, broke with him in 1911 and 1912 over disputes regarding the factors leading to the fixation of personalities. Adler went on to develop the individual psychology system which defined such concepts as inferiority complex, spoiled child, sibling rivalry, and adult lifestyle—all terms he coined. His views that care in child upbringing are critical throughout one's life—a corollary of the fixed personality hypothesis—remains unquestioned to this day. Jung took a more quantitative approach devising one of the earliest, effective personality instruments: The word association test. While taking very distinctive views of the mechanisms by which personalities are molded prior to becoming fixed, Freud, Adler, and Jung all agreed that personality is formed by the age of six. This conviction remains, to this day, an unchallenged cornerstone of modern psychology.

Building upon Jung's thinking, journalist Katharine Briggs and her daughter Isabel Myers, starting in 1923, developed a personality type indicator and associated measurement instrument. Known as the Myers-Briggs Type Indicator (MBTI), Form A had been copyrighted in 1943 and was revised and modernized a dozen times since. In 1975, starting with form F, Consulting Psychology Press became the publisher. Because of its long history and practicality in mainstream psychology, the MBTI has generated thousands of papers and over 1300 dissertations. Many other typing instruments have also been developed. The Journal of Psychological Types has now published 49 volumes devoted to typological investigations.

The MBTI instrument, encompassing a 93 items exam (in the 1998 Form M), produces a score on one of each of four dimensions: Extroverted-Introverted, Sensing-Intuitive, Thinking-Feeling, and Judging-Perceiving. Each personality type exhibits a preference along each of the four dimensions. Jungians offer the analogy of handedness—a right-handed person is not one who never uses the left hand, but rather one who prefers to use the right hand: Strongly or barely at all. A total of 16 potential personality type combinations are thus discernible with the MBTI test. The first dimension—a scale preference from extroverted to introverted—is perhaps the best known and most pronounced personality type. Within the business world, extroversion has long been linked to effective sales ability; introverts have often succeeded in more solitary tasks such as accounting or computer programming. Likewise, the other dimensions of the MBTI have been linked to various aspects of job performance and success. Extensive quantitative validation research—for instance, finding a correlation between salesperson's performance and MBTI scores—has fortified the applicability of this instrument in the workplace environment. Today, more than 2.5 million MBTI tests, and countless other instruments, are administered annually in the workplace.

(Historical recounting in this section is largely based on Psychological Testing at Work by Edward Hoffman)

Statistical Modeling and Credit Scoring Methodology

Decisioning is the science of mass producing predictive actions. Specified data that may have predictive value (predictive data) is collected prior to the decision point, a statistical model is utilized to generate a prediction with regard to some future event, and an action is taken based on the prediction. For example, in the consumer credit scoring domain, a branch of decisioning, the predictive data includes information found in a prospective borrower credit report and application form, the future event is the eventual performance of the loan if originated, and the predictive action may be the decision of whether to originate the loan at all. In the invented psychometric credit scoring methodology, the predictive data would also include information generated by psychometric instruments or interviews. We use the term “psychometric interview,” herein to highlight the interrogative nature of the psychometric instruments with no intended loss of generality.

The statistical modeling paradigm relies on the assumption that historical data present clues with respect to the manner through which predictivity may be obtained. Arguably, the process of human learning and human experience gathering rely on the same assumption. The statistical formalism divides the historical data into a collection of data point samplers—individual instances that are largely independent of each other and that would have required individual predictions. In the credit scoring domain, each loan, or sometimes each borrowing entity, may be thought of as a sampler. Each sampler is farther divided into component of information that would have been available prior to the decision point (the predictive data) and subsequent information that identify the outcome of the future event. Data can be considered historical only once enough time has passed that the outcome of the future event can be ascertained.

Predictive data is typically processed so as to provide a collection of numerical predictive variables. For example, the ratio of a borrower's income to its debt service load may be computed to form one such variable. Likewise, data identifying the ultimate disposition of the future event is processed into a numerical (sometimes binary) target variable. An example of a binary target variable may be the determination of whether a loan proved to have been good (e.g., GOOD LOAN=1, BAD LOAN=0) where a loan is defined as good if it remains current or paid off within a specified time period, and bad otherwise. (An example of a non-binary—continuous—target variable may be the net present value of all profits and losses a loan generated over its lifetime; in the credit scoring arena, however, preference is often placed on direct GOOD/BAD binary target variables since measures such as profitability are influenced by many non-credit-related factors)

A modeling data set is a collection of samplers where for each one there is a series of predictive variables and one target variable. A predictive model is a mathematical formula that provides a relationship between the target variable and associated predictive variables. Linear Regression, perhaps the best-known predictive model (although certainly not the best-performing one), for instance, is predicated on formulas where each predictive variable has a set weight in predicting the target variable and that the respective weights can be surmised from the historical data through algebraic techniques. More sophisticated modeling techniques that are popular today include Logistic Regression (a modification of the Linear Regression methodology that is specifically adopted to instances of a binary target variable), Neural Network (a modeling technique that is loosely modeled after the manner biological neurological system may operate), Binary Trees, Clustering Algorithms, and many others. Since the practical application of all these algorithms require the use of high-speed computers, they are often referred to, collectively, as machine learning techniques.

Historical data that was utilized in deriving the predictive model formula is often referred to as training data and the model derivation process itself is sometimes referred to as model training. As with human training and experience gathering, the model training process identifies instances of the information available prior to the decision point as contrasted with the ultimate outcome after the respective decisions. The validation of the performance of a predictive model is achieved by testing the performance of the model with respect to historical data that was not used in the training process. Such historical data, identified as test or validation data, represent a plausible simulation of the environment that will exist when the model will be deployed in a real system. For each sampler in the test data, the model formula is applied to the predictive variables to produce a prediction of the target variable. Since the test data is, itself, historical, the true target variable is known. The difference between the prediction and true target, the prediction error, is a measure of the performance of the model. A metering of the magnitude of the prediction errors performed on a historical test data set that is large enough to be statistically significant can provide a very accurate indication of the performance of the model.

Creditworthiness models are often configured such that their predictions are presented in the form of a credit score. For instance, a score of zero may be defined as an indication that a loan is unlikely to perform satisfactorily (a “BAD LOAN” outcome) and a score of 1000 may be defined as an indication that it is very likely to perform satisfactorily (“GOOD LOAN”). (FICO scores, as another example, use a 200-950 range). The performance of the model is then metered by how high it scores historical test data loans that subsequently proved to be good and how low it scores those that proved to be bad. A well-behaving model will exhibit a behavior where the proportion of bad loans among the population in each score band (score range) is decreasing as the score is increasing (e.g., there is a smaller percentage of BAD LOANS among those samplers whose score was in the 800-850 score band than the 750-800 band).

The modeling paradigm presumption provides that a predictive model that was trained using historical data and validated on separate, blind, historical data would—in the absence of extraordinary outside influences and mass behavioral changes—provide a comparable level of predictivity with respect to subsequent live (operational) data. In a live score-oriented credit origination system, data that is available prior to the origination decision are processed to generate predictive variables, and the predictive model formula is then used to generate a credit score. The score is then directly interpreted as the likelihood of the originated loan ultimately becoming bad. If, given the terms of the loan, that likelihood is unacceptable from the lender's business point of view then the loan, as applied, is declined.

### SUMMARY OF INVENTION

In accordance with the present invention, there is provided an automated system and method for scoring borrowing organizations creditworthiness, which uses a predictive model to evaluate responses to an automatically administered psychometric interview by individuals associated with the borrowing organization and estimates the likelihood of repayment based on learned relationships among known variables. These relationships enable the system to estimate a probability of default for each prospective loan or other transaction presented in the form of a creditworthiness score. This score may then be provided as output to a human decision-maker involved in processing the transaction, or as part of a larger automated loan decisioning system. The system periodically monitors its performance, and regularly redevelops the model utilizing subsequent loan performance data.

The primary users of such a system, it is envisioned, would be banks and other financial institutions who lend to businesses. However, other entities facing relationship decisions whose ultimate outcome critically depends on the character of the management of the enterprise may also benefit from the systems. Such entities may include venture capitalists, shareholders, customers, vendors and others contemplating long-term relationships.

### BRIEF DESCRIPTION OF DRAWINGS

FIG. 1 is a block diagram of the process flow of an operational system

FIG. 2 is a block diagram of the process flow of a pilot system

FIG. 3 is a block diagram of the process flow of score fusion of psychometric and other credit scores

FIG. 4 is a block diagram of the process flow of a typographical bureau

### DETAILED DESCRIPTION

The Figures depict preferred embodiments of the present invention for purposes of illustration only. One skilled in the art will readily recognize from the following discussion that alternative embodiments of the structures and methods illustrated herein may be employed without departing from the principles of the invention described herein.

Psychometric Scoring System

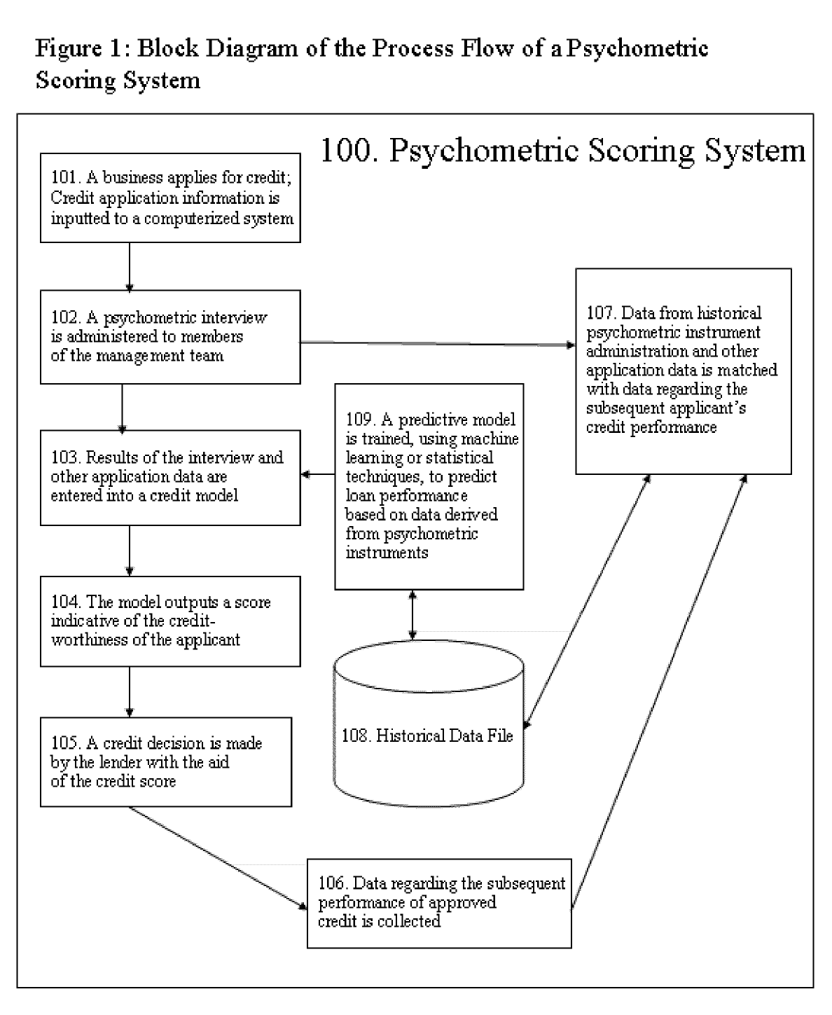

Referring now to FIG. 1, there is shown a block diagram of a typical implementation of a Psychometric Scoring System 100 in accordance with the present invention. Credit application information is applied to Psychometric Scoring System 100 via an Input Process 101. A Psychometric Interview Administration Process 102 is utilized to administer a psychometric interview to selected members of the management of the credit applicant. In the preferred embodiment, the interview is administered via a secure internet interface and consists of a series of personality typing questions. Methods for administering questions via an Internet interface are readily known to one skilled in the arts. In the preferred embodiment, the selected members of management include the Chief Executive Officer or equivalent, the Chief Financial Officer or equivalent, and the most important management individual not already selected. The answers provided by the interviewees to the psychometric interview administered by Psychometric Interview Administration Process 102, combined with credit application information gathered by Input Process 101 are supplied as inputs to a Credit Model Processing Module 103. In the preferred embodiment, Credit Model Processing Module 103 utilizes a computer system and software written in the PHP language which may be run on a variety of conventional hardware platforms. In accordance with the software program instructions and data model, Credit Model Processing Module 103 outputs a score via Output Process 104 indicative of the creditworthiness of the applicant. The score outputted via Output Process 104 is then utilized by the user lender to make a credit decision using Credit Decision Process 105. In the event that a decision to extend credit is made and credit is extended, subsequent loan performance data is collected via Loan Performance Data Harvesting Process 106. In the preferred embodiment, data harvesting is achieved through monthly reports of loan performance for a portfolio of loans with the data archived on a computer disk system and managed by a commercially available data base management system such as Microsoft Access. Data collected via the Loan Performance Data Harvesting Process 106 and completed interviews generated by the Psychometric Interview Administration Process 102 is matched by Data Matching Process 107 to form a Historical Data File 108 where each record represents one loan and contains the completed psychometric interview as well as subsequent loan performance information. In the preferred embodiment, the Historical Data File 108 is maintained on a computer disk system and managed by a commercially available data base management system such as Microsoft Access. At regular intervals, the Historical Data File 108 is utilized to refine and redevelop a predictive model using Machine Learning Module 109. Methods for machine learning statistical modeling are readily known to one skilled in the arts and include such techniques as linear and non-linear regression, neural networks, clustering algorithms, decision trees, logistics regression, genetic algorithms, and others. In the preferred embodiment, a logistics regression method is utilized. The redeveloped model produced using Machine Learning Module 109 is then supplied to Credit Model Processing Module 103 for use in subsequent credit scoring transactions.

One may consider an implementation of such a system in a manner analogous to that of current consumer credit scores. Lenders, prior to origination, administer a psychometric test to members of the management of each borrowing business. The test and the administration process are designed to frustrate potential attempts to prepare for or otherwise cheat the intent of the exam (for instance, by making each exam unique and administered at the lender's facility). The completed exams, analogous to a consumer's credit report, are then the basis from which a score is computed. The score indicates the likelihood of satisfactory loan performance.

Whereas a simplistic model may focus on only one individual, or take a single-person exam-evaluation mindset, a more sophisticated approach may involve the analysis of the management as an integral team. Under that approach, the completed exams are identified based on the positions of the individuals within management and the statistical model is trained with the benefit of this information. An even more sophisticated loan origination decision process may seek to combine creditworthiness estimation (scores) derived by different processes to form one combined score. Such a combined score may incorporate currently-existing financial statements and business bureaus score with the proposed psychometric exam score.

The invention operational system employs the statistical credit scoring methodology described above where predictive variables are derived from psychometric interviews applied to members of the management of a borrowing institution. To be effective in a realistic setting, the system must also attain a degree of robustness against environmental factors, manipulation attempts, and outright cheating—while retaining a reasonable level of convenience to the impacted constituencies.

Once the system is operational, a psychometric interview administration protocol would be followed. The protocol would determine which members of the management of a business applying for a loan would need to be examined, a secure manner by which to assure the identity of those examined, and methods to prevent individuals from manipulating their own score (through studying or “cheating”).

Identity assurance would likely be done through methods of direct physical security—such as requiring the interview to be administered at the lender's (or affiliate) site, where an ID check would be practicable. Independent Notary Public providers might also be recognized in assuring proper identification of examinees when conditions make this potential option more practical (e.g., allow an interviewee to be administered the interview in the presence of a Notary Public and certify proper identity under oath). If identity assurance is not considered a concern, then an online or a telephone interview administration service may provide a level of convenience to the interviewee.

To reduce the ability of interviewees to prepare for interviews, algorithms via which each administered interview is unique may be employed. A large pool of questions may be initially created, and each administered interview will draw upon only a small fraction of those questions. No two interviews will thus have more than a small number of questions in common. The psychometric profession has developed a quiver of proven methods to identify likely lying. Methods such as “trick questions” (questions that honest examinees almost always answer in a particular—often not very self-complimentary—manner, whereas dishonest examinees sometimes answer differently) have a surprisingly strong track record in identifying dishonest interviewees. Less definitive methods—such as recognizing an unlikely preponderance of unusual correlation between answers to questions—may segregate those who answer untruthfully together with those whose personality is extraordinarily atypical. If the predictive model determine that this “extraordinarily atypical” category of borrower is particularly risky, then it does not really matter if some members of that category came to be such through dishonesty.

Whereas a simplistic model may focus on only one individual, or take a single-person exam-evaluation mindset, a more sophisticated approach may involve the analysis of the management as an integral team. Under that approach, the completed exams are identified based on the positions of the individuals within management and the statistical model is trained with the benefit of this information. It may be that the best-performing management teams have specific combinations of management personalities (for instance, a moderately aggressive Chief Executive Officer (CEO) and a conservative Chief Financial Officer (CFO)) and that the worst performing teams have other combinations (for instance, a team that is entirely comprised of aggressive personalities). Fortunately, the invention does not require us to qualitatively research and understand these dynamics. If such correlation, in fact, exists; then any reasonable modeling technique would have the effect of discovering and accounting for it.

Once the proper psychometric interviews have been administered to members of the management of the borrowing business, the results of the measures will be used to generate predictive variables and those in turn, via the credit model, would be used to generate a credit score. The credit score would then be utilized within a lending policy instituted by the lender and constituted to achieve specified business objectives. For instance, a simplistic lending policy might simply decline all loans where the credit score is below a specified threshold. A more nuanced policy might set multiple thresholds indicating risk level where loans must have more rigorous terms, require approval by a more senior loan officer, or demand stricter covenants.

Whatever the final credit decision may be, a record of the administered interview, together with the credit decision will be retained. That record will, subsequently, be appended with data indicating the credit performance of the corresponding loan. Ultimately, once enough time has passed such that it may be determined, retrospectively, if the loan proved to have been good or bad, the record will become part of the historical data that will be used to train or test subsequent model versions.

Pilot Psychometric Scoring System

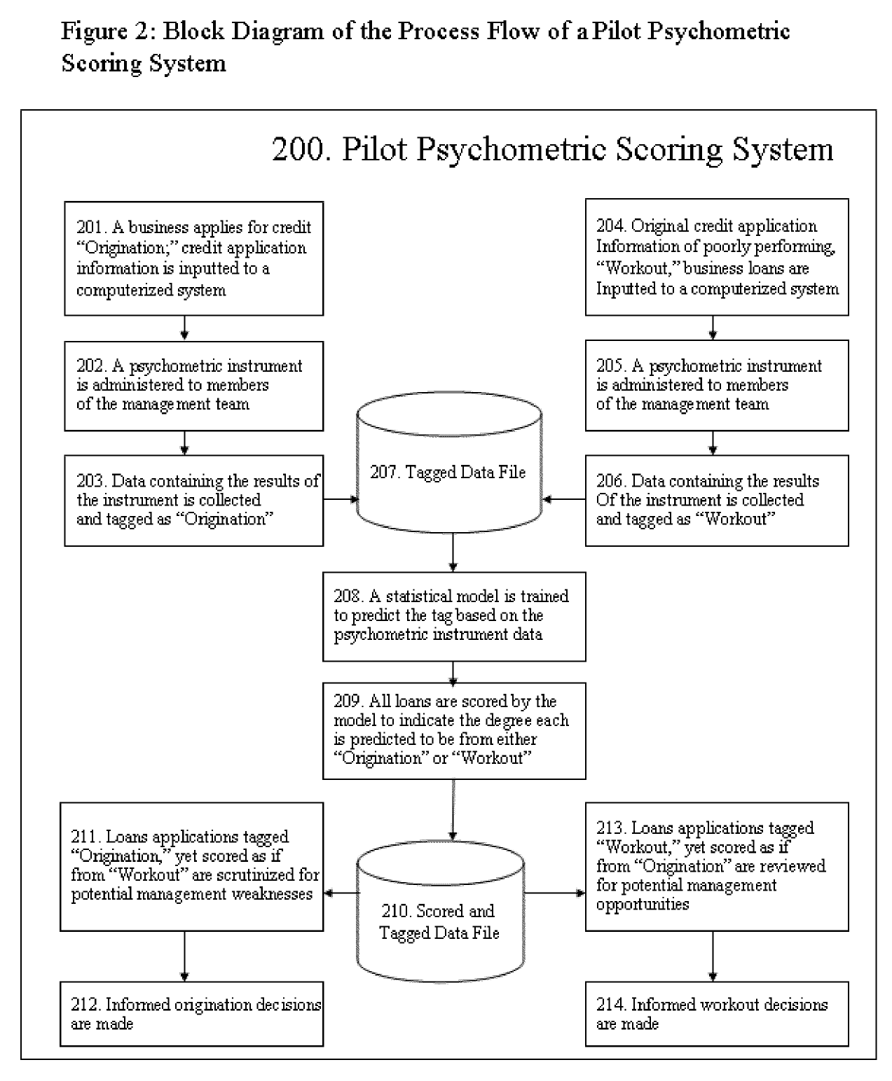

Referring now to FIG. 2, there is shown a block diagram of a typical implementation of a Pilot Psychometric Scoring System 200 in accordance with the present invention. In the preferred embodiment, a Pilot Psychometric System 200 is utilized initially to develop an initial credit model, with that credit model becoming the initial credit model of the Psychometric Scoring System 100 that is used by the Credit Model Processing Module 103. Credit application information is applied to Pilot Psychometric Scoring System 200 via an Input Process 201. A Psychometric Interview Administration Process 202 is utilized to administer a psychometric interview to selected members of the management of the credit applicant. In the preferred embodiment, the interview is administered via a secure internet interface and consists of a series of personality typing questions. Methods for administering questions via an Internet interface are readily known to one skilled in the arts. The answers provided by the interviewees via the Psychometric Interview Administration Process 202 are combined with credit application information gathered by Input Process 201 and tagged as “Origination” by Data Preparation Process 203 with each loan represented by one tagged data file record. Contemporaneously, credit application information of loans that have subsequently failed to perform to the lender's satisfaction is also applied to system 200 via an Input Process 204. A Psychometric Interview Administration Process 205 is utilized to administer a psychometric interview to selected members of the management of the creditor. In the preferred embodiment, the interview is administered via a secure internet interface and consists of a series of personality typing questions. Methods for administering questions via an Internet interface are readily known to one skilled in the arts. In the preferred embodiment, the psychometric interview administered by Psychometric Interview Administration process 205 is identical to the psychometric interview administered by Psychometric Interview Administration process 202 and the selection methodology for interviewee members of management is also identical. In the preferred embodiment, the selected members of management include the Chief Executive Officer or equivalent, the Chief Financial Officer or equivalent, and the most important management individual not already selected. In the preferred embodiment, members of management of non-performing creditors are engaged in a renegotiation process, commonly known as a “Workout” with the lender and acceptance of the psychometric interview becomes part of the process. In the preferred embodiment, the psychometric interview is designed to select questions to which the answers are unlikely to change with the passage of time. The answers provided by the interviewees via the Psychometric Interview Administration Process 205 are combined with credit application information gathered by Input Process 204 and tagged as “Workout” by Data Preparation Process 206 with each loan represented by one tagged data file record. The data files prepared by Data Preparation Processes 203 and 206 are combined to form Tagged Data File 207. In the preferred embodiment, the Tagged Data File 207 is stored on a computer disk system and managed by a commercially available data base management system such as Microsoft Access. Tagged Data File 207 is used by Modeling Process 208 to train a statistical model that predicts the tag of each record utilizing the loan application and interview answers of the corresponding record. The predictions of the statistical model generated by Modeling Process 208 are generated in the form of a credit score. Methods for statistical modeling are readily known to one skilled in the arts and include such techniques as linear and non-linear regression, neural networks, clustering algorithms, decision trees, logistics regression, genetic algorithms, and others. In the preferred embodiment, a logistics regression method is utilized. All loans represented in the Tagged data Set 207 are scored using the statistical model generated by Modeling Process 208 by Scoring Process 209 with the scores appended to each record to form Scored and Tagged Data File 210. In the preferred embodiment, the Scored and Tagged Data File 210 is stored on a computer disk system and managed by a commercially available data base management system such as Microsoft Access. The Scored and Tagged Data File 210 is supplied to Origination Outlier Scrutinization Process 211 which is used to identify loans tagged as “Origination” whose score is more indicative of loans tagged “Workout” and scrutinizes the details of such loans for the cause of their non-conformity. In the preferred embodiment, Origination Outlier Scrutinization Process 211 involves a computerized sorting and grouping of the “Origination”-tagged record of the Scored and Tagged Data File 210 based on score, the selection of a score threshold, and a human analysis of all loans past the score threshold. Information gathered from Origination Outlier Scrutinization Process 211 is utilized in the Final Approval Process 212, or subsequent tracking, of loans. Contemporaneously, the Scored and Tagged Data File 210 is supplied to Workout Outlier Scrutinization Process 213 which is used to identify loans tagged as “Workout” whose score is more indicative of loans tagged “Origination” and scrutinizes the details of such loans for the cause of their non-conformity. In the preferred embodiment, Workout Outlier Scrutinization Process 213 involves a computerized sorting and grouping of the “Workout”-tagged record of the Scored and Tagged Data File 210 based on score, the selection of a score threshold, and a human analysis of all loans not past the score threshold. Information gathered from Workout Outlier Scrutinization Process 213 is utilized in the Workout Process 214, or subsequent tracking, of loans.

An operational scoring system 100, as described above, would score new loan applications using a model that was developed based on the experience of the performance of prior granted loans. The subsequently granted loans, in due course, will provide data for the training of future model revisions. While this overall operational process is self-sustaining, there may be difficulty in achieving the initial model. Since, at this time, lenders do not administer psychometric interviews to borrower, there is no historical data available from which to construct a credit model. If one were to begin administering psychometric interviews to borrowers today, one would still need to wait until enough time has passed so that those loans now originating have enough track record to be classified as good or bad. This waiting period may take years. In the meantime, test administration would be strictly for research purposes with no origination decision impacted by these premodel-development interviews. Arguably, the motivation of the borrowers and employees of the lending institution to follow precise protocols during this prolonged prebenefit period may wear thin. Furthermore, until the first model is in production, there will be no way to optimize or tune the interviews. Poor interview questions (i.e., questions with no incremental predictive value) and weak administration protocols will not be ferreted out until there is enough data to build the first model. If one imagines that a few iterations might prove necessary before an economically viable system is implemented, then this process might be long and awkward indeed.

In most predictive decisioning environment, this initial hurdle is unavoidable. The first model cannot be constructed until enough samplers of pre-decision data have been collected and enough time to allow those samplers to become historical (by waiting for the predicted event to become manifest) has passed. Data collected after the predicted event is materially different—often through the impact of the event—from that which would have been available at decision time. For instance, a consumer credit model that attempts to predict personal bankruptcies using credit report information can not use the credit reports as they are when the bankruptcies are filed, but must rather use the credit reports as they are when the model would normally be used (i.e., at the time of loan origination). This is because the credit report at bankruptcy time would likely be materially different than at loan origination time and would likely contain many clues that would not have been available earlier.

The only time this data collection waiting rule can be plausibly relaxed is when one can demonstrate that the collected data would not have likely changed materially during the waiting period. For example, if one were to build a predictive medical model were stable factors such as adult height and blood type are used to predict the likelihood of the onset of some medical condition (for instance, a heart attack), it is acceptable to measure those factors after the onset of the condition for the purpose of building a predictive model. Fortunately, in the instance of psychometric testing and personality typing, the weight of evidence indicates that adult personalities do not change even in the wake of dramatic or traumatic events (such as the loss of one's business might be). This stability of personality opens the possibility of developing pilot models of economic value without the burdensome need for a waiting period. Such a pilot model could provide initial benefit while data is collected for the more rigorous subsequent revision (when truly historical data will be available).

One potential application of this thinking involves the administering, over a short period of time, of the psychometric interview to members of management of borrowers whose loans are in bad standing and also members of management of borrowers whose loans are in good standing. The former category might be found in a lender's loan workout section (a department dedicated to salvaging value from written-off, or otherwise poorly performing, loans). The latter category might be found among borrowers whose debt is in good standing for a sufficiently long time and who are in additional origination negotiation with the lender (for instance, for additional credit). It may even be possible to simply use any loan applicant as a proxy for good-standing loans, since only a small percentage of granted loans ever become bad in any event. Both such groups are in a position of needing the lender's favorable actions and would thus likely comply with a psychometric metering mandate.

Once such pilot data is collected, a model that attempt to predict, given the collected management psychometric data for each loan, whether it is from the pool of good or bad loans. Standard machine learning techniques, as described above, would be readily usable to construct such a model and the model could be immediately validated. Assuming the model exhibits a statistically significant predictive capacity; those loans that the model mis-classifies would be candidates for actions. For instance, if the model, presented with a loan that came from the origination (“good”) pool, determines that it possess predictive characteristics more commonly found in the workout (“bad”) pool, this may be indicative of the need for farther credit evaluation actions. Likewise, if the model finds a loan from the workout pool to be more consistent with those found in the origination pool—that loan may be viewed as a more likely candidate for a successful workout. By providing its prediction in the form of a score, the product will be readily usable in the formation of credit granting policy.

Score Fusion System

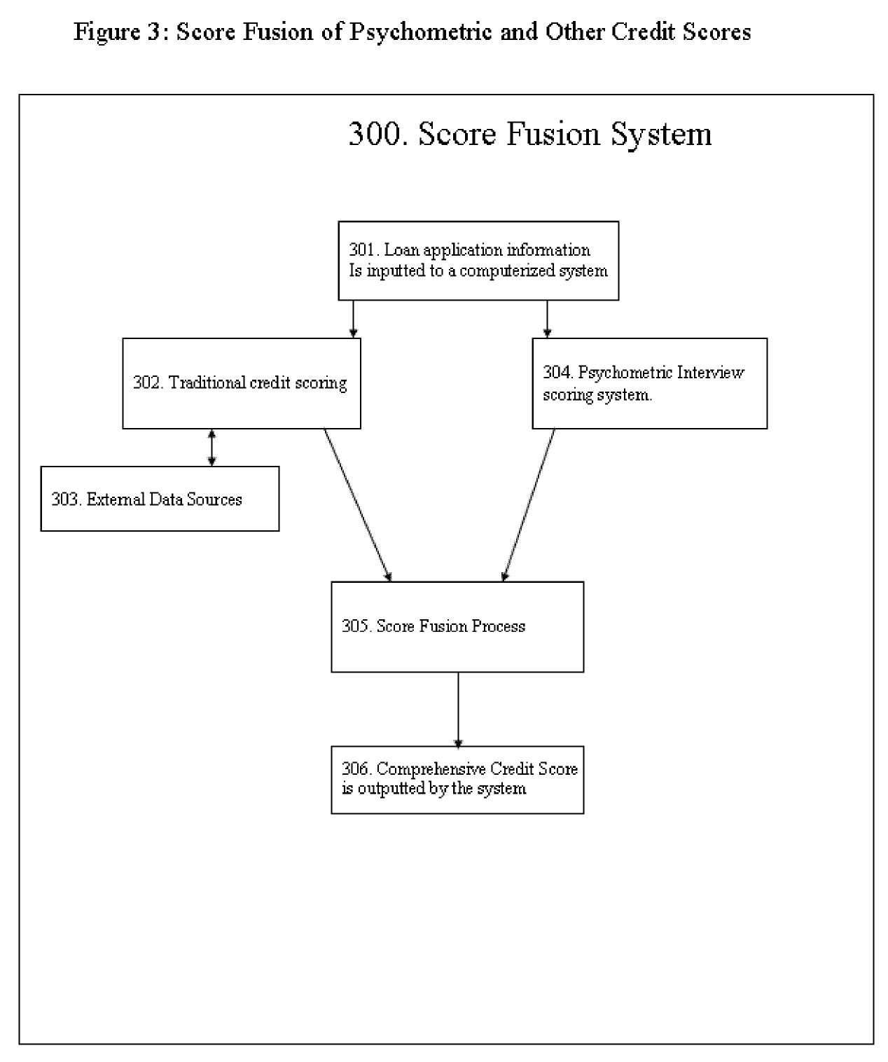

Referring now to FIG. 3, there is shown a block diagram of a typical implementation of a Score Fusion System 300 in accordance with the present invention. Credit application information is applied to Score Fusion System 300 via Input Process 301. A Traditional Credit Scoring Technique Process 302 is used to generate a traditional credit score based on credit application information inputted via Input Process 301. Systems and methods for generating a traditional credit scoring techniques are readily known to one skilled in the arts and are commercially available from a multitude of providers including Fair Isaac Corporation, D&B, and Moody's. The Traditional Credit Scoring Technique Process 302 may require additional information that can be obtained from Outside Data Sources 303. System and methods for accessing outside sources for credit related information are readily known to one skilled in the arts and are commercially available from a multitude of outside data providers including Experian, Equifax, Transunion, D&B, and Moody's. Contemporaneously, credit application information inputted via Input Process 301 is applied to a Psychometric Interview Scoring System 304 to generate a psychometric interview credit score. In the preferred embodiment, the Psychometric Interview Scoring System 304 are formed from the previously described Psychometric Scoring System 100 with the inputted credit application supplied via the previously-described credit application information Input Process 101 and outputted credit score as the previously-described score outputted via Output Process 104. The traditional credit score generated by Traditional Credit Scoring Technique Process 302 and the psychometric interview score generated by Psychometric Interview Scoring System 304 are combined by Score Fusion Process 305. System and methods for combining scores are readily known to one skilled in the arts and include such techniques as table look-up, linear and non-linear regression, neural networks, clustering algorithms, decision trees, logistics regression, genetic algorithms, and others. In the preferred embodiment, a table look-up with smoothing between grid points is utilized. The output of the Score Fusion Process 305 is a comprehensive credit score indicative of the likely creditworthiness of the scored credit application and is outputted by the system via Output Process 306.

It is not the intent of this invention to completely displace all other manners of evaluating the creditworthiness of businesses. Even a management team with the most pristine personalities would have a hard time repaying loans if the revenue stream and business plan are inadequate. Current creditworthiness evaluation techniques—largely based on reviewing financial statements, business plans, tax filings, business bureaus data, and other accounting-oriented information—should not be discarded.

When two statistical methodologies are based on radically different mechanisms, there is a lesser opportunity that their predictive power is duplicative. This property, referred to as orthogonality, when present, allows for the combination of the two methodologies to gain a combined value. Credit scores formed through psychometric methodologies and through accounting-oriented approaches have the opportunity to be orthogonal.

Consider, for example, a situation where bad loans are rare (but individually expensive to the lender). Suppose some credit risk evaluation method is able to finger 30% of the originated loans as “risky” and, in fact, nearly every bad loan is destined to emerge from amongst the fingered loans. By itself, such a method may only be marginally useful—the lender is likely to find it too onerous to decline 30% of otherwise-approved loans to eliminate the credit loss problem. If a second credit risk evaluation method had exactly the same performance, it will be of equally marginal usefulness. If the two methods identify largely the same 30% of loans as “risky”, then there is no value in combining the two methods. However, if the two methods are completely orthogonal, good loans that are (mis-)labeled by one method as risky are no more likely to be so labeled by the other method than other good loans.

Consequently, only 9% (30% of 30%) of all loans would be labeled as risky by both methods. These 9% would continue to include nearly every bad loan. The utility of the combined method, presumably, would be better than marginal.

When two (or more) statistical predictive methods exhibit partial or complete orthogonality, it is possible to combine them into one method with a higher degree of predictive power than either of the two methods alone. When the predictive methods produce scores, this combination process can be referred to as score fusion and the outcome can itself be in the form of score.

Typographical Bureau

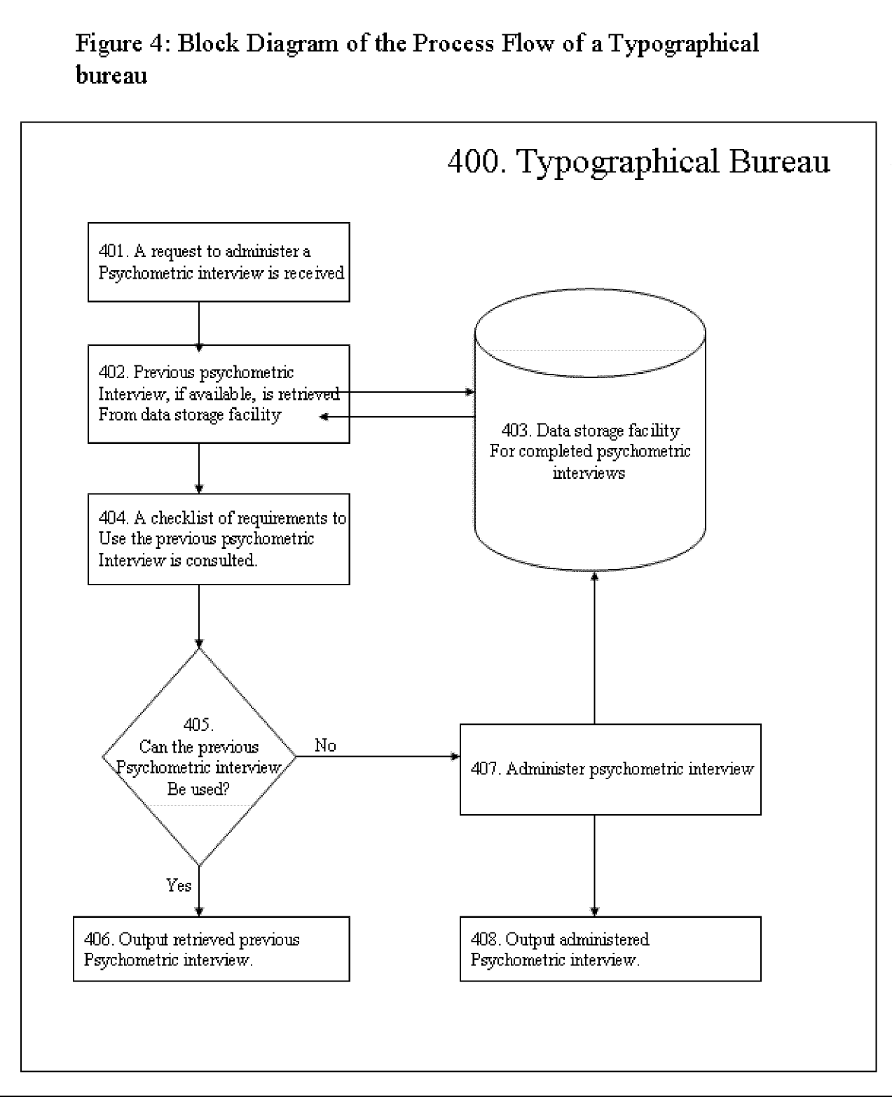

Referring now to FIG. 4, there is shown a block diagram of a typical implementation of a Typographical Bureau 400 in accordance with the present invention. Requests for Psychometric Interviews are received via a computer network Request Receiving Process 401. In the preferred embodiment, requests for psychometric Interviews are made by the Psychometric Scoring System 100 when it becomes necessary to administer a psychometric interview by the Psychometric Interview Administration Process 102. Upon the receipt of a psychometric interview request by Request Receiving Process 401, Retrieval Process 402 queries Data Storage Facility 403 to retrieve, if available, a copy of a previously completed psychometric interview by the same individual interviewee. In the preferred embodiment, Data Storage Facility 403 is a high speed computer disk system managed by a commercially available data base management system such as the Microsoft Access system. A Verification Process 405 establishes if the requirements to utilize the retrieved completed interview are present. In the preferred embodiment, the requirements include the completeness and existence of a completed interview, the absence of ambiguity regarding the exactness of the match of the identity of the interviewee, an limit on the time span since the retrieved interview was completed, an authorization provided by a competent party or parties at the time the retrieved interview was completed for subsequent reutilizing, an authorization provided by a competent party or parties at request time, and the appropriateness of the completed interview with respect to the requested interview. In the preferred embodiment, the time span requirement is no greater than seven years. In the preferred embodiment, an authorization by the interviewee given either at the time of the interview or at the time of the request for retrieval will satisfy the requirement for competent authorization. In the preferred embodiment, an identical social security number and a largely similar name accounting for marriage- and divorce-related name changes as well as non-unique spellings and shortening of some names is considered to satisfy the requirement for a non-ambiguous identity match. If the Verification Process 405 finds that all requirements are met, the system outputs the retrieved psychometric interview via Output Process 406. In the preferred embodiment, Output Process 406 delivers the completed interview through the same computer network and to the same computer process that initiated the initial request for psychometric interview through Request Receiving Process 401. If the Verification Process 405 finds that not all requirements are met, a psychometric interview is administered to the interviewee via Psychometric Interview Administration Process 407. In the preferred embodiment, the interview is administered via a secure internet interface and consists of a series of personality typing questions. Methods for administering questions via an Internet interface are readily known to one skilled in the arts. The system outputs the completed psychometric interview generated by the Psychometric Interview Administration Process 407 via an Output Process 408. In the preferred embodiment, the Output Process 408 delivers the completed interview through the same computer network and to the same computer process that initiated the initial request for psychometric interview through Request Receiving Process 401. In addition, a copy of the completed interview generated by the Psychometric Interview Administration Process 407 is forwarded to the Data Storage Facility 403 to be available for future queries.

The non-volatile nature of personality type would tend to suggest that repeated administration of a measurement interview to the same individual would produce similar results and would thus be wasteful and unnecessarily inconvenient to all involved. A trusted repository of typographical information would thus appear appropriate.

One plausible implementation of a typographical bureau would combine the function of trusted repository with that of model building. Every time a member of the management of a loan-applicant is administered a typographical interview, all data generated by that event is forwarded to the bureau for safekeeping. In the event the same individual is in a position where, again, a typographical examination is required—perhaps as a consequence of another loan application—even if at the time the individual is representing a different borrower or applying to a different lender, the bureau could be requested to produce the result of the prior examination rather than engage in the hassle of a repeat exam. In addition, the lender would agree to provide the bureau with information regarding loan decisions and subsequent loan performance for those loans that were originated with the aid of the psychometric model. This data, in turn, will become the historical data from which future model revisions will be trained.

Once such a trusted bureau is well established, it may serve other constituencies. At the request (or, at least with the consent) of the examinee, typographical information may be released to other entities that may have a legitimate interest: For example, employers, business partners, vendors, etc.

1. In a computer having a processor and storage, a computer-implemented process for determining a creditworthiness metric of a credit applicant, comprising the steps of: obtaining past psychometric interviews data for processing by the computer;generating a predictive model with the processor from the past psychometric interviews data; storing a representation of the predictive model in the computer storage; receiving current psychometric interviews data for processing by the processor; and generating a computer signal indicative of the creditworthiness of the current credit applicant, wherein the processor generates the computer signal by applying the current psychometric interview data to the stored predictive model.

2. The computer-implemented process of claim 1, further comprising the steps of: monitoring a performance metric of the computer generated predictive model, wherein the processor monitors the performance metric; comparing the performance metric with a predetermined performance level; and generating and storing a new predictive model from past psychometric interview data responsive to the performance level exceeding the performance metric, wherein the new predictive model is generated by the processor and stored in the computer storage.

3. The computer-implemented process of claim 2, wherein the performance metric comprises: a non-performing loan detection rate measurement; and a false positive rate measurement.

4. The computer-implemented process of claim 1, further comprising the steps of: obtaining past credit application related data;incorporating past credit application data to become part of past psychometric interviews data; obtaining current credit application data; and incorporating current credit application data to become part of past psychometric interviews data.

5. The computer-implemented process of claim 1, wherein the psychometric interview data comprises: answers to a psychometric interview provided by at least one interviewee associated with the credit applicant.

6. The computer-implemented process of claim 5, wherein the psychometric interview data comprises: answers to a psychometric interview provided by at least one interviewee associated with the credit applicant selected based upon a pre-determined association relationship.

7. The computer-implemented process of claim 5, wherein the psychometric interview data further comprises: the amount of time each interviewee took to answers each question of the psychometric interview.

8. The computer-implemented process of claim 1, wherein the psychometric interview data comprises: answers to a psychometric interview provided by a plurality of interviewees associated with the credit applicant.

9. The computer-implemented process of claim 8, wherein the interviewees associated with the credit applicant include: an individual performing the functions of the chief executive officer of the credit applicant; and an individual performing the functions of the chief financial officer of the credit applicant.

10. The computer-implemented process of claim 1, further comprising the steps of: administering a psychometric interview to at least one interviewee associated with the loan applicant.

11. The computer-implemented process of claim 10, further comprising the steps of: generating a psychometric interview by selecting interview questions from a pool of questions.

12. The computer-implemented process of claim 1, wherein the credit applicant is a business.

13. The computer-implemented process of claim 12, wherein the credit worthiness metric is an estimation of the likelihood of success of a contemplated business relationship.

14. The computer-implemented process of claim 12, wherein the contemplated business relationship is a loan.

15. The computer-implemented process of claim 12, wherein the contemplated business relationship is an equity investment.

16. The computer-implemented process of claim 1, further comprising the steps of: obtaining current credit score data; and combining the current credit score data with the computer signal indicative of the creditworthiness of the current credit applicant.

17. In a computer having a processor and storage, a computer-implemented process for determining a creditworthiness metric of loans in a collection of loans, comprising the steps of: obtaining psychometric interviews data relating to non-performing loans in the collection of loans for processing by the computer; obtaining psychometric interviews data relating to performing loans in the collection of loans for processing by the computer; generating a predictive model with the processor from the psychometric interviews data; storing a representation of the predictive model in the computer storage; and generating a computer signal indicative of the creditworthiness of each loan in the collection of loans, wherein the processor generates the computer signal by applying each loan's psychometric interview data to the stored predictive model.

18. The computer-implemented process of claim 17, further comprising the steps of: identifying loans where the actual performance and computer signal indicative of the creditworthiness are divergent.

19. In a computer having a processing and storage, a computer-implemented process for managing psychometric interviews generated for creditworthiness evaluation purposes, comprising the steps of: obtaining a request for a psychometric interview to an identified interviewee; determining if a usable completed psychometric interview is available to be retrieved;administering a psychometric interview to the identified interviewee if no usable completed psychometric interview is available to be retrieved; archiving the completed psychometric interview; and responding to the request with data representing the completed psychometric interview.

20. The computer-implemented process of claim 19 where the psychometric interview is administered via the Internet.
